(19) United States
(12) Patent Application Publication
(10) Pub. No.: US 2023/0088752 A1
(43) Pub. Date: Mar. 23, 2023

(54) Parallel Wireless Circuitry Operations

(71) Applicant: Apple Inc., Cupertino, CA (US)

(72) Inventors: Shadi Iskander, Ergolding (DE); Christian Hofmann, Muenchen (DE); Panagiotis Botsinis, Muenchen (DE); Sameh M. Eldessoki, Muenchen (DE); Silvano Gori, Marktl (DE)

(21) Appl. No.: 17/556,616

(22) Filed: Dec. 20, 2021

Related U.S. Application Data
(60) Provisional application No. 63/246,744, filed on Sep. 21, 2021.

(51) Int. Cl. H04B 7/06; H04B 17/382

(52) U.S. Cl. CPC H04B 7/0639; H04B 7/061; H04B 17/382

(57) ABSTRACT

An electronic device may include wireless circuitry. The wireless circuitry may include one or more antenna arrays coupled to baseband processing circuitry by parallel radio-frequency signal (receive) chains. To more efficiently perform beam measurements, and thereby more efficiently determine cell status, beam measurements may be performed by the radio-frequency receive chains in a parallel manner. If desired, beam measurements for one or more inter-frequency and/or intra-frequency layers may each be parallelized. If desired, beam measurements during a discontinuous reception mode of operation may be parallelized.

This application claims the benefit of U.S. provisional patent application No. 63/246,744, filed Sep. 21, 2021, which is hereby incorporated by reference herein in its entirety.

### FIELD

This disclosure relates generally to electronic devices, including electronic devices with wireless circuitry.

### BACKGROUND

Electronic devices are often provided with wireless capabilities. An electronic device with wireless capabilities has wireless circuitry that includes one or more antennas coupled to one or more radios.

### SUMMARY

An electronic device may include wireless circuitry. The wireless circuitry may include one or more antenna arrays coupled to baseband processing circuitry by parallel radio-frequency signal (receive) chains. When performing data conveyance with external equipment such as network equipment, the wireless circuitry may measure receive signal beams to determine cell status. The wireless circuitry may perform multiple sets of receive beam measurements for each frequency layer to determine the cell status. Accordingly, the wireless circuitry may use different spatial receive beams across the one or more antenna arrays to provide a spatial sweep for a complete spatial coverage. To more efficiently perform these beam measurements, and thereby more efficiently determine cell status, the wireless circuitry may use multiple radio-frequency receive chains in parallel to perform these receive beam measurements.

In particular, the network equipment (e.g., the network) along with the electronic device may specify measurement gap windows, SMTC windows, and SSB bursts. The wireless circuitry may perform the SSB burst measurements at any suitable time (e.g., during SMTC windows that overlap the measurement gap windows, or during SMTC windows that are outside of or do not overlap the measurement gap windows). Two or more receive chains may perform these SSB burst measurements in parallel, each of these measurements associated with a spatially different receive beam.

In some illustrative configurations, receive beam measurements for one or more inter-frequency layers and/or receive beam measurements for one or more intra-frequency layers may be parallelized. If desired, receive beam measurements for an inter-frequency layer may overlap measurement gap windows. If desired, receive beam measurements for an intra-frequency layer may occur between the measurement gap windows.

In some illustrative configurations, parallelized beam measurements may occur during a discontinuous reception mode of operation such as during a discontinuous reception OFF time period, or if desired, during a discontinuous reception ON time period.

An aspect of the disclosure provides an electronic device. The electronic device can include one or more antennas associated with one or more antenna arrays. The electronic device can include a first radio-frequency receive chain coupled to the one or more antennas and a second radio-frequency receive chain coupled to the one or more antennas. The electronic device can include one or more processors configured to perform a first beam measurement using the first radio-frequency receive chain while performing a second beam measurement using the second radio-frequency receive chain.

An aspect of the disclosure provides a method of operating wireless circuitry. The method can include operating the wireless circuitry in a discontinuous reception mode during a time period. The method can include performing, by a first radio-frequency receive chain in the wireless circuitry, a first beam measurement associated with a cell status during the time period. The method can include performing, by a second radio-frequency receive chain in the wireless circuitry, a second beam measurement associated with the cell status while performing the first beam measurement.

An aspect of the disclosure provides a method of operating wireless circuitry communicatively coupled to a cellular network. The method can include operating the wireless circuitry to perform beam measurements during a plurality of measurement time periods having a periodicity. The method can include performing, by a first radio-frequency receive chain in the wireless circuitry, a first beam measurement during a given measurement time period in the plurality of measurement time period and during a timing window associated with the cellular network The method can include performing, by a second radio-frequency receive chain in the wireless circuitry, a second beam measurement during the given measurement time period while performing, by the first radio-frequency receive chain, the first beam measurement.

### BRIEF DESCRIPTION OF THE DRAWINGS

FIG. 1 is a block diagram of an illustrative system having an electronic device with wireless circuitry in accordance with some embodiments.

FIG. 2 is a block diagram of illustrative wireless circuitry having one or more antenna arrays coupled to baseband processing circuitry via radio-frequency signal chains in accordance with some embodiments.

FIG. 3 is an illustrative timing diagram showing how a radio-frequency signal chain performs signal beam measurements in accordance with some embodiments.

FIG. 4 is an illustrative timing diagram showing how two radio-frequency signal chains perform signal beam measurements in accordance with some embodiments.

FIG. 5 is an illustrative timing diagram showing how four radio-frequency signal chains perform signal beam measurements in accordance with some embodiments.

FIG. 6 is an illustrative timing diagram showing how a radio-frequency signal chain performs signal beam measurements relative to operation in a discontinuous reception mode in accordance with some embodiments.

FIG. 7 is an illustrative timing diagram showing how four radio-frequency signal chains perform signal beam measurements relative to operation in a discontinuous reception mode in accordance with some embodiments.

FIG. 8 is an illustrative timing diagram showing how two radio-frequency signal chains perform signal beam measurements for an intra-frequency layer in accordance with some embodiments.

FIG. 9 is an illustrative timing diagram showing how four radio-frequency signal chains perform signal beam measurements for an intra-frequency layer in accordance with some embodiments.

FIG. 10 is an illustrative timing diagram showing how two radio-frequency signal chains perform signal beam measurements for an inter-frequency layer and an intra-frequency layer in accordance with some embodiments.

FIG. 11 is an illustrative timing diagram showing how four radio-frequency signal chains perform signal beam measurements for an inter-frequency layer and an intra-frequency layer in accordance with some embodiments.

### DETAILED DESCRIPTION

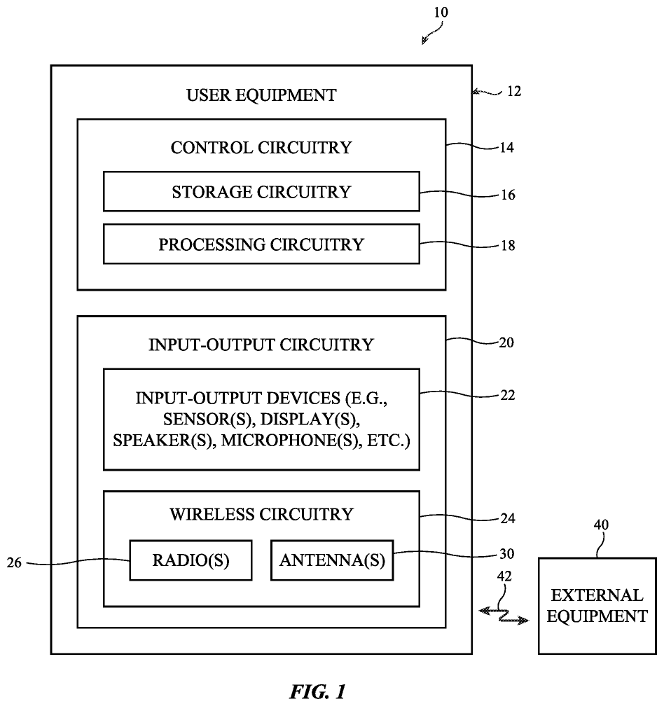

User equipment 10 of FIG. 1 may be a wireless communication device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment. User equipment 10 may sometimes be referred to herein as electronic device 10 or device 10.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors, microprocessors, microcontrollers, digital signal processors, host processors, baseband processor integrated circuits, application specific integrated circuits, central processing units (CPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors, temperature sensors, etc. In some configurations, keyboards, headphones, displays, pointing devices such as trackpads, mice, and joysticks, and other input-output devices may be coupled to device 10 using wired or wireless connections.

Input-output circuitry 20 may include wireless circuitry 24 to support wireless communications and/or radio-based spatial ranging operations. Wireless circuitry 24 may include one or more antennas 30. Wireless circuitry 24 may also include one or more radios 26. Each radio 26 may include circuitry that operates on signals at baseband frequencies (e.g., baseband processor circuitry), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 30. These components of each radio 26 may be mounted onto a respective substrate or integrated into a respective integrated circuit, chip, package (e.g., system-in-package), or system-on-chip (SOC). If desired, the components of multiple radios 26 may share a single substrate, integrated circuit, chip, package, or SOC.

Antenna(s) 30 may be formed using any desired antenna structures. For example, antenna(s) 30 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Wireless circuitry 24 may include any desired number of antennas 30. Some or all of the antennas 30 in wireless circuitry 24 may be arranged into one or more phased antenna arrays (e.g., for conveying radio-frequency signals over a steerable signal beam). Filter circuitry, switching circuitry, impedance matching circuitry, and/or other antenna tuning components may be adjusted to adjust the frequency response and wireless performance of antenna(s) 30 over time.

Transceiver circuitry in radios 26 may convey radio-frequency signals using one or more antennas 30 (e.g., antenna(s) 30 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 30 may transmit the radio-frequency signals by radiating the radio-frequency signals into free space (or to free space through intervening device structures such as a dielectric cover layer). Antenna(s) 30 may additionally or alternatively receive the radio-frequency signals from free space (e.g., through intervening devices structures such as a dielectric cover layer). The transmission and reception of radio-frequency signals by antenna(s) 30 each involve the excitation or resonance of antenna currents on an antenna resonating element in the antenna by the radio-frequency signals within the frequency band(s) of operation of the antenna.

Each radio 26 may be communicatively coupled to one or more antennas 30 over one or more radio-frequency transmission lines. One or more radio-frequency transmission lines may be shared between radios 26 and/or antennas 30 if desired. Radio-frequency front end (RFFE) modules may be interposed on one or more radio-frequency transmission lines. The radio-frequency front end modules may include substrates, integrated circuits, chips, or packages that are separate from radios 26 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines.

Radios 26 may use antenna(s) 30 to transmit and/or receive radio-frequency signals within different frequency bands at radio frequencies (sometimes referred to herein as communications bands or simply as a “bands”). The frequency bands handled by radios 26 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Each radio 26 may transmit and/or receive radio-frequency signals according to a respective radio access technology (RAT) that determines the physical connection methodology for the components in the corresponding radio. One or more radios 26 may implement multiple RATs if desired. As just one example, the radios 26 in device 10 may include a UWB radio for conveying UWB signals using one or more antennas 30, a Bluetooth (BT) radio for conveying BT signals using one or more antennas 30, a Wi-Fi radio for conveying WLAN signals using one or more antennas 30, a cellular radio for conveying cellular telephone signals using one or more antennas 30 (e.g., in 4G frequency bands, 5G FR1 bands, and/or 5G FR2 bands), an NFC radio for conveying NFC signals using one or more antennas 30, and a wireless charging radio for receiving wireless charging signals using one or more antennas 30 for charging a battery on device 10. This example is merely illustrative and, in general, radios 26 may include any desired combination of radios for covering any desired combination of RATs. If desired, antenna(s) 30 may be operated using a multiple-input and multiple-output (MIMO) scheme and/or using a carrier aggregation (CA) scheme.

Radios 26 may use antenna(s) 30 to transmit and/or receive radio-frequency signals 42 to convey wireless communications data between device 10 and external wireless communications equipment 40 such as a base station, one or more other network components for a (radio) access network, one or more other network components linking device 10 to a core network, a wireless access point, etc. The wireless communications data conveyed by radios 26 may, for example, include data that has been encoded into corresponding data packets such as wireless data associated with a telephone call, streaming media content, internet browsing, wireless data associated with software applications running on device 10, email messages, etc.

The example of FIG. 1 is merely illustrative. While control circuitry 14 is shown separately from wireless circuitry 24 in the example of FIG. 1 for the sake of clarity, wireless circuitry 24 such as radio 26 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24 or radio 26).

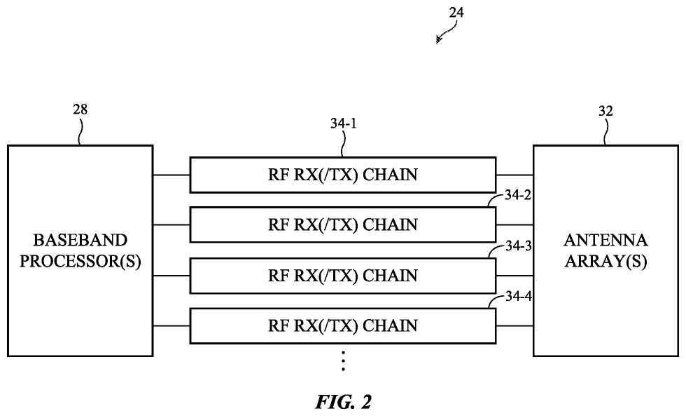

FIG. 2 is a diagram of illustrative wireless circuitry having one or more antennas coupled to baseband processing circuitry via radio-frequency signal chains. As shown in FIG. 2, wireless circuitry 24 may include antennas 30 organized as one or more antenna arrays 32. Antenna arrays 32 may be used to convey (e.g., transmit and receive) radio-frequency signals using spatial signal beams (e.g., using transmit and/or receive beams oriented in different spatial directions). As an example of transmission, each antenna array 32 may generate a signal beam that is steerable in one or more spatial directions, to which the radio-frequency signals are transmitted. As an example of reception, each antenna array 32 may be configured to receive a signal beam at a particular spatial direction, from which the radio-frequency signals are received.

In the example of FIG. 2, radio-frequency receive chains 34-1, 34-2, 34-3, and 34-4 may use one or more antenna arrays 32 to receive radio-frequency signals and pass the received radio-frequency signals to one or more baseband processors 28 (e.g., implemented as a portion of control circuitry 14 or radio 26). Each radio-frequency signal receive (or transmit) chain (sometimes referred to herein as a radio-frequency chain or radio-frequency signal chain) may include a chain of electronic components for handling (e.g., receiving) radio-frequency signals. The radio-frequency signal chain (e.g., receive or transmit chain) may include one or more filters, mixers, attenuations, detectors, amplifiers, and other components that form a portion of wireless circuitry 24 such as a cellular radio 26.

If desired, radio-frequency signal chains 34-1, 34-2, 34-3, and 34-4 may each include a corresponding radio-frequency transmit portion in addition to the receive portion. If desired, wireless circuitry 24 may include any suitable number of radio-frequency receive and/or transmit chains coupling one or more antenna arrays 32 to one or more baseband processors 28. If desired, one or more radio-frequency chains 34-1, 34-2, 34-3, and 34-4 may be coupled to and used by or shared with antennas 30 outside of antenna arrays 32.

User equipment (e.g., wireless circuitry 24 in user equipment 10) may be configured to receive multiple spatial receive (RX) signal beams (e.g., signal beams oriented at different spatial directions) to work with and measure signals at one or more frequencies such as at NR FR2 frequencies, as an example. The reception and measurement of these spatial receive signal beams may include the measurement of signal power, signal quality, signal timing, etc. and may be used to determine cell status (e.g., a signal power of the cell, a signal quality of the cell, timing and frequency synchronization of the cell, and other characteristics indicative of cell status). If desired, the same spatial receive beam may perform multiple measurements and average across the multiple measurements to arrive at an averaged measurement, which is used to determine a cell status. User equipment with a single radio-frequency signal receive chain may be unable to measure multiple spatial receive beams simultaneously. Such user equipment may be required to perform measurements on multiple spatial receive beams sequentially in order to have a clear picture of cell status.

In some illustrative configurations described herein as examples, wireless circuitry 24 in FIG. 2 may be configured to communicate with a network (e.g., network equipment serving as external equipment 40 in FIG. 1). The network (equipment) may provide to the user equipment (e.g., wireless circuitry 24) a SSB (Synchronization Signal and Physical Broadcast Channel, or simply Synchronization Signal Block) distribution or SSB bursts over time, and may provide the SMTC (SSB-based Measurement Timing Configuration) windows to limit the occasions when the above-mentioned sequential measurements can happen. In some scenarios, the network equipment may also provide to the user equipment the measurement gap windows. In combination with measurement gaps (MGs) in connected mode (as specified between the network and user equipment), the limitations further increase, since the window specified by the SMTC and measurement gap (MG) window must overlap in order to perform these measurements. In other scenarios, a measurement gap window, or more specifically, overlap with the measurement gap window, may not be required to perform these measurements.

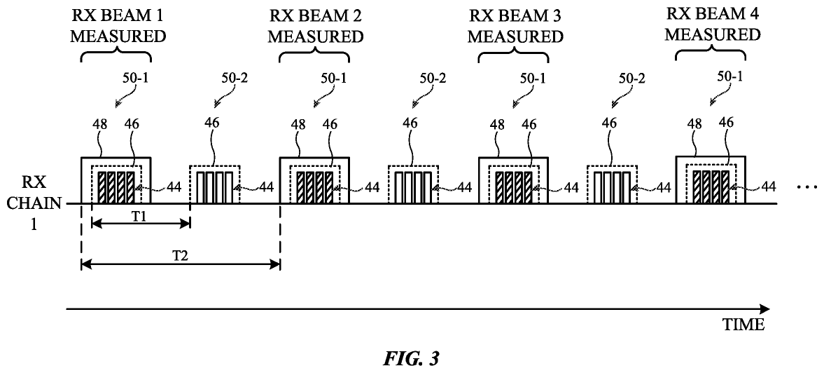

Measurement configurations described herein (e.g., in connection with FIGS. 3-11) are merely illustrative. In general, SSB burst measurements may be performed at any suitable time (e.g., during SMTC windows that overlap the measurement gap windows, or during SMTC windows that are outside of or do not overlap the measurement gap windows). As examples, the measurement gap window, or more specifically, overlap with the measurement gap window may be required to perform measurements in scenarios such as for inter-frequency layer measurements, where the inter-frequency SSB is not contained in the active downlink bandwidth part of the user equipment (e.g., when configuration “interFreqeuncyConfig-NoGap-r16” is set to False), for intra-frequency layer measurements where the intra-frequency SSB is outside of the active downlink bandwidth part of the user equipment, etc. As further examples, the measurement gap window, or more specifically, overlap with the measurement gap window may not be required to perform measurements in scenarios such as for inter-frequency layer measurements where the inter-frequency SSB is completely contained within the active downlink bandwidth part of the user equipment (e.g., when configuration “interFreqeuncyConfig-NoGap-r16” is set to True), for intra-frequency layer measurements where the intra-frequency SSB is within the active downlink bandwidth part of the user equipment, etc.

Configurations in which receive beam measurements for one or more NR FR2 frequency layers are performed by wireless circuitry 24 are described herein as illustrative examples. If desired, wireless circuitry 24 may similarly perform receive beam measurements in combination with other protocols and/or radio access technologies. Arrangements in which one frequency layer is considered are sometimes described herein as an illustrative example. If desired, the embodiments described herein may similarly apply to co-existence of multiple frequency layers. In fact, in these co-existence arrangements, with different and overlapping SMTC windows, more complex scenarios may arise, which would enhance the advantages of the embodiments described herein.

FIG. 3 is an illustrative timing diagram for operating a radio-frequency receive chain such as receive chain 34-1 in FIG. 2. In particular, external equipment associated with the network such as external equipment 40 in FIG. 1 may convey synchronization signal bursts (e.g., SSB bursts) 44 periodically. Each burst 44 may include one or more SSB transmitted by the external equipment using different spatial transmit beams (e.g., in different spatial directions). The receive chain in user equipment may be configured to use one or more antennas and/or antenna arrays to measure each of the desired RX beams during STMC windows 46.

To perform these beam measurements, the SMTC window 46 may overlap MG window 48. This overlap may be required to perform measurements in some scenarios such as for inter-frequency layer measurements, where the inter-frequency SSB is not contained in the active downlink bandwidth part of the user equipment (e.g., when configuration “interFreqeuncyConfig-NoGap-r16” is set to False), or for intra-frequency layer measurements where the intra-frequency SSB is outside of the active downlink bandwidth part of the user equipment, as examples. The external equipment may specify information (e.g., periodicity and window duration) associated with the SMTC and the MG for performing these RX beam measurements.

In the illustrative example of FIG. 3, a SMTC periodicity of T1 (e.g., 5 ms, 10 ms, 20 ms, 40 ms, 80 ms, 160 ms etc.) and a MG periodicity of T2 (e.g., 20 ms, 40 ms, 80 ms, 160 ms, etc.) may be specified by the external equipment and/or the user equipment. Additionally, a duration or length of the SMTC window (e.g., 1 ms, 2 ms, 3 ms, 4 ms, 5 ms, etc.) and MG window (e.g., 1.5 ms, 2 ms, 3.5 ms, 4 ms, 5.5 ms, 6 ms, 10 ms, 20 ms, etc.) may also be specified by the external equipment. If desired, a SSB burst periodicity different than the SMTC periodicity, and a number of synchronization signals in each burst may also be specified by the external equipment and/or the user equipment. These periodicities, window durations, and other specified characteristics are merely illustrative and may be varied across different sets of measurements, if desired.

Within a MG, user equipment in some configurations can only practically measure one RX beam at a time (e.g., assuming that the measurement gap size is a length of time and the SSB length falls completely inside or is shorter than the measurement gap length). In this illustrative example, the user equipment may require 4 coarse RX beams to achieve spherical coverage. In other words, the user equipment may steer its spatial RX beam and perform measurements in 4 different spatial directions in order to be able to cover the complete space around it (e.g., 360 degrees in the azimuth and elevation angles). The RX beams used for the purposes of mobility measurement are sometimes denoted as “coarse” beams in order to distinguish them from the “narrow” RX beams used for data reception (e.g., associated with the conveyance of data in user applications). In some illustrative configurations, user equipment may be configured to implement 4 coarse RX beams, 8 coarse RX beams, more than 8 coarse RX beams or any other suitable number of coarse RX beams to provide complete spatial coverage. The measurement of one spatial RX beam within an MG window is merely illustrative. If desired, more than one RX beam, each used to for measurement of a different frequency layer, may be sequentially measured during a single MG window. Configurations in which a single RX beam is measured during a MG window are described herein as an illustrative example and may be analogous applied to the multiple RX beams measured during the MG window.

In the illustrative example of FIG. 3, user equipment, requiring 4 coarse RX beams for spatial coverage and having a single receive chain to do so, may require 4 SMTC measurement occasions in order to perform a complete measurement of the cell. With the timing configuration of this example, this procedure may require a total measurement time of approximately 3*T2+(SMTC window duration), the 3 representing the first three periods of RX beam measurements, T2 representing MG periodicity, and the SMTC window duration representing the duration of a RX beam measurement (e.g., a given operation 50-1 in FIG. 3).

Accordingly, as shown in FIG. 3, four sets of RX beams (RX beams 1, 2, 3, 4) are measured on four separate and sequential occasions (e.g., at operations 50-1). At intervening operations 50-2, the SSB burst 44 is not measured since MG window 48 does not overlap SMTC window 46.

In the illustrative example described in connection with FIG. 3, the wireless circuitry may take a substantial time to perform measurements for a single cell because the multiple required measurements are done sequentially by a single receive chain. The situation may become much more complex if there are other cells and/or frequencies with overlapping SMTCs (SMTC windows) given that the user equipment may have to finish multiple occasions of beam measurements for a first frequency before starting multiple occasions of beam measurements for the next frequency.

To improve the efficiency of these types of beam measurements, user equipment such as user equipment 10 having wireless circuitry 24 with multiple receive chains may be used. As an example, user equipment 10 may already include multiple receive chains to satisfy different cellular requirements such as carrier aggregation, multi-SIM (Subscriber Identity Module), etc. Accordingly, it may be desirable to utilize one or more of these receive chains to perform measurements on different coarse RX beams in parallel, as desired.

Doing so may advantageously 1) eliminate the need for measurement gaps (thus increasing measurement rate), 2) control the periodicity of measurements by the user equipment, 3) allow a higher MG and/or SMTC periodicity, hence increasing the throughput, 4) reduce the amount of time to obtain a complete frequency reading, 5) measure simultaneously overlapping SMTCs from different frequencies, and 6) provide a more accurate view of cell power and quality, especially if the user equipment is moving (given that multiple RX beams are measured at the same time instance across multiple receive chains). These advantages are merely illustrative, and other advantages may also be imparted by the embodiments described herein.

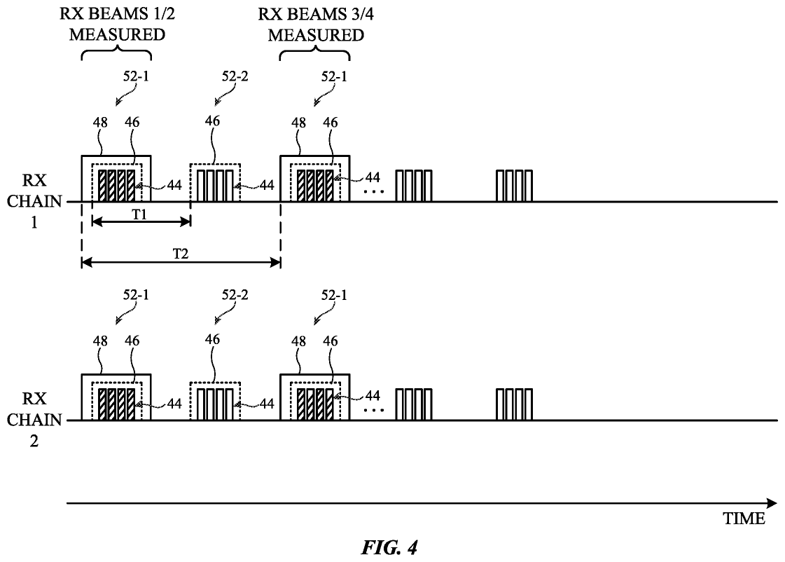

FIG. 4 shows an illustrative timing diagram in which user equipment such as user equipment 10 uses two receive chains such as receive chains 34-1 and 34-2 in FIG. 2 (e.g., one as a primary receive chain and the other one as an additional receive chain) to measure RX beams. In the illustrative example of FIG. 4, in order to measure 4 RX beams (as an example to provide complete spatial coverage), each RX chain may be active only for 2 SMTC measurement periods or measurement gap periods instead of 4 SMTC measurement periods or measurement gap periods as in the example of FIG. 3. In this example, the total measurement time of approximately 1*T2+(SMTC window duration), which is significantly shorter than the total measurement time in the FIG. 3 example.

In particular, at operations 52-1, receive chains 34-1 and 34-2, using one or more antenna arrays 32, may operate in parallel to measure RX beams associated with SSB bursts 44 during SMTC window 46 that overlaps measurement gap window 48. At the first temporally overlapping instance of operation 52-1, receive chain 34-1 may measure a first RX beam, while receive chain 34-2 measures a second RX beam. At the second temporally overlapping instance of operation 52-1, receive chains 34-1 may measure a third RX beam, while receive chain 34-2 measures a fourth RX beam. Assuming in this example that an MG is required in order to measure this frequency layer, at intervening operations 52-2, the SSB bursts 44 are not measured since MG window 48 does not overlap SMTC window 46.

Accordingly, these four RX beam measurements for different spatial RX beams may be indicative of cell status for a particular frequency layer. If desired, additional RX beam measurements may be performed for the same frequency layer (e.g., sequentially after the third and fourth RX beam measurements using one or both of the first and second receive chains and/or in parallel to one of the four RX beam measurements using additional receive chains) in scenarios where more than 4 occasions of measurements are needed to provide complete spatial coverage or gather cell status information.

In some illustrative arrangements, user equipment may be required to support a minimum of 2 Search and Measurement processing engines (e.g., as specified in 3GPP RAN4 performance requirements), and accordingly, may be capable of measuring at least 2 frequency layers in parallel. Given that in some user equipment configurations, the radio or baseband processor is agnostic to the active radio-frequency channel frequency, performing the illustrative operation described in FIG. 4 (and in other figures) may not imply any additional implementation costs (e.g., processing capabilities and memory) for the radio, since the radio may also be capable of measuring 2 independent RX beams in parallel on the same radio-frequency channel. If desired, there may be additional requirements for radio-frequency components of the user equipment to be configured to form 2 independent RX beams within the same frequency layer.

Accordingly, if desired, the additional (non-primary) receive chain such as receive chain 34-2 may be only selectively used to perform parallel beam measurement operations as described in connection with FIG. 4. During other time periods, the additional receive chain may be used to perform other types of signal measurement operations.

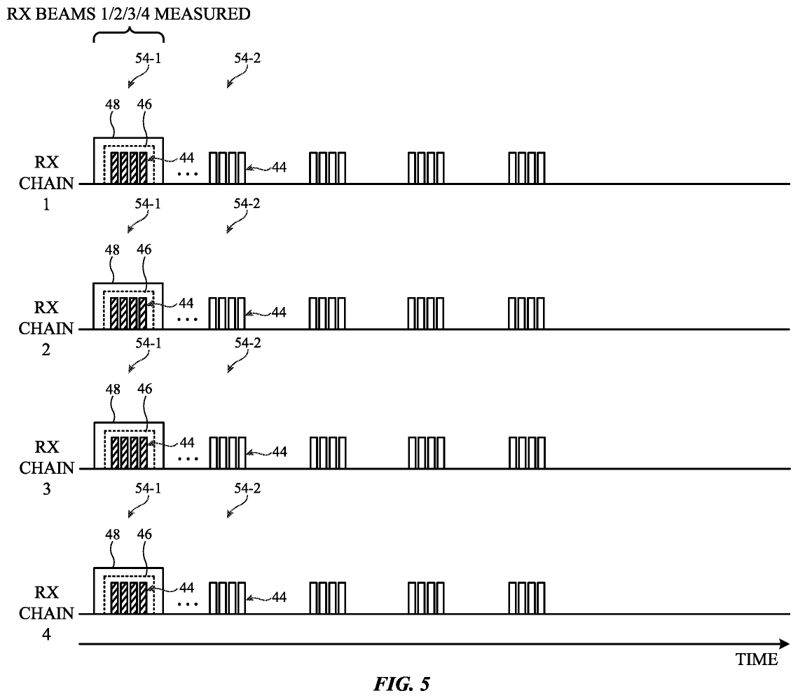

FIG. 5 shows an illustrative timing diagram in which user equipment such as user equipment 10 uses four receive chains such as receive chains 34-1, 34-2, 34-3, and 34-4 in FIG. 2 (e.g., one as a primary receive chain and the other three as additional receive chains) to measure RX beams. In the illustrative example of FIG. 5, in order to measure 4 RX beams (as an example to provide complete spatial coverage), each RX chain may be activated for only 1 SMTC measurement period in the example of FIG. 5. In this example, the total measurement time may be only the duration of a single occasion of RX beam measurement, which is significantly shorter than the total measurement time in the FIG. 3 example and the total measurement time in the FIG. 4 example.

In particular, at operation 54-1, receive chains 34-1, 34-2, 34-3, 34-4, using one or more antenna arrays 32, may operate in parallel to measure RX beams associated with SSB bursts 44 during SMTC window 46 that overlaps measurement gap window 48. At the first and only temporally overlapping instance of operation 54-1, receive chain 34-1 may measure a first set of RX beams, while receive chain 34-2 measures a second set of RX beams, while receive chain 34-3 measures a third set of RX beams, and while receive chain 34-4 measures a fourth set of RX beams. At operation 54-2, the SSB bursts 44 are not measured since beam measurements have already been completed in addition to MG window 48 not overlapping SMTC window 46.

Accordingly, these four sets of RX beam measurements for different spatial RX beams may be indicative of cell status for a particular frequency layer. If desired, additional RX beam measurements may be performed for the same frequency layer (e.g., sequentially after the one of the four sets of RX beam measurements using one of the four receive chains and/or in parallel to one of the four sets of RX beam measurements using additional receive chains) in scenarios where more than 4 occasions of measurements are needed to provide complete spatial coverage or gather cell status information.

With different periodicity of measurement gaps and SMTCs, the user equipment such as user equipment 10 may select an appropriate number of RX chains to achieve optimal performance such as through parallelizing operations as described in connection with FIGS. 4 and 5 without sacrificing power consumption. As an example, activating a RX chain twice may be similar from a power consumption perspective to activating each of two RX chains once at the same time.

In general, the illustrative examples in FIGS. 3-5 show SSB burst measurements being performed during SMTC windows that overlap the measurement gap windows. This overlap may be required to perform measurements in some scenarios such as for inter-frequency layer measurements, where the inter-frequency SSB is not contained in the active downlink bandwidth part of the user equipment (e.g., when configuration “interFreqeuncyConfig-NoGap-r16” is set to False), or for intra-frequency layer measurements where the intra-frequency SSB is outside of the active downlink bandwidth part of the user equipment, as examples. If desired, instead of or in addition to performing SSB burst measurements during SMTC windows that overlap the measurement gap windows, SSB burst measurements may be performed during SMTC windows that are outside of the measurement gap windows.

The illustrative operations of wireless circuitry 24 in user equipment 10 as described in connection with FIGS. 3-5 are sometimes described in the context of performing beam measurements while in a connected mode of operation (e.g., measurement gap windows interspersed among or in preparation for periods of normal data conveyance for user applications). If desired, RX beam measurements may occur during any suitable mode of operation of wireless circuitry 24 and/or user equipment 10.

As an illustrative example, wireless circuitry 24 may also perform RX beam measurements during discontinuous reception (sometimes referred to as a discontinuous reception mode), which can occur in the idle mode or the connected mode. Operation using discontinuous reception includes operating wireless circuitry 24 during ON periods in which regular data conveyance with the network occurs and operating wireless circuitry 24 during OFF periods during which portions of wireless circuitry 24 are in a low-power state and/or turned off. The DRX OFF time periods, during which there is no regular data reception and RX beam measurements may occur, may be much longer than measurement gaps. In this case, the overlap of the SMTC window and the MG window may not be a very critical issue. However, some user equipment having wireless circuitry operating in NSA/ENDC (Non-Standalone/E-UTRA-NR Dual Connectivity) mode may require that the DRX time periods from both MCG (Master Cell Group) and SCG (Secondary Cell Group) overlap, in order to use the overlapping DRX time periods to perform RX beam measurements. If desired, user equipment having wireless circuitry operating with discontinuous reception in connected mode (e.g., in Connected-DRX) may also perform RX beam measurements based on discontinuous reception time periods. The embodiments described below may be similarly applicable to these configurations (e.g., DRX in idle mode or connected mode), and if desired, to other configurations.

In an illustrative scenario, the user equipment (e.g., a radio component in the user equipment) may have to wake-up for each SMTC window to perform the RX beam measurements, which implies that not only radio-frequency components (e.g., one or more receive chains, radio-frequency front-end circuits, etc.) are powered on, but also the different lower layers to process the information from the radio-frequency components (e.g., processing circuitry) are also powered on. If desired, the information may be delayed from being propagated until the upper layers are not in a sleep mode.

Advantageously, if the RX chains are parallelized, then the RX beam measurements may be finished early and the user equipment may be able to reduce the overall power ON duration. In particular, the power benefit may come from the fact that, in some illustrative user equipment arrangements, the power consumption required for activating multiple (N) RX chains for a time period of duration T is lower than the power consumption for activating a single RX chain for N time periods of duration T each. This may be as a consequence of the power consumption of certain hardware components shared across RX chains such as Phase-locked loops, memory, interfaces, control entities, etc., being independent of the number of active RX chains, but being dependent on the total duration of the power ON state.

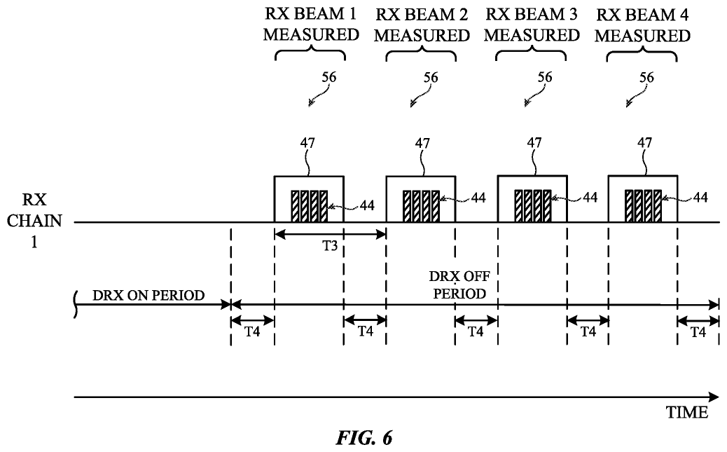

FIG. 6 shows an illustrative timing diagram of user equipment operating a single RX chain during a DRX OFF time period. In particular, the single RX chain may sequentially measure RX beams associated with SSB bursts 44 during SMTC windows 47 at operations 56 in the DRX OFF time period. Accordingly, the actual reception OFF (e.g., radio inactivity or radio low power) period T4 during the DRX OFF time period is only between or outside of the measurement periods of RX beams during operations 56.

In particular, as shown in the example of FIG. 6, a single receive chain may perform four sequential RX beam measurements at four operations 56 during the DRX OFF time period. Each set of RX beam measurements may be used to measure a different set of SSB bursts 44, thereby helping provide complete spatial coverage. The sets of beam measurements may each occur with an SMTC window having a periodicity of T3. The sequential nature of these RX beam measurements may limit the power-savings during the DRX OFF time period (e.g., to only during time periods T4) as operations 56 may require portions of the wireless circuitry to be turned on even during the DRX OFF time period.

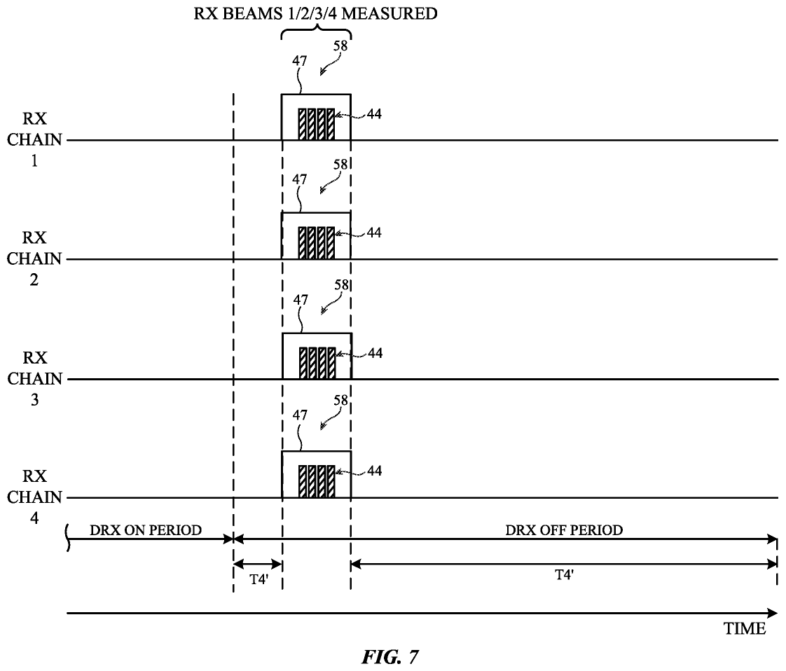

FIG. 7 shows an illustrative timing diagram of user equipment such as user equipment 10 operating multiple RX chains in parallel during the DRX OFF time period. As shown in FIG. 7, by operating multiple RX chains in parallel to perform measurements for RX beams at operations 58, the actual OFF (inactivity or low-power) period T4′ in the DRX OFF time period is significantly increased relative to the illustrative operation in FIG. 6, thereby reducing power consumption relative to the illustrative operation in FIG. 6.

As an example, user equipment 10 may operate receive chains 34-1, 34-2, 34-3, and 34-4 in FIG. 2 to perform beam measurements in parallel during the DRX Off time period, with each receive chain handling a different set of spatial beam measurements using one or more antenna arrays. Accordingly, in the example of FIG. 7, temporally overlapping instances of a SMTC window are used to perform RX beam measurements for the different SSB bursts 44.

Depending on the number of implemented RX beams and the number of available RX chains, the user equipment such as user equipment 10, if desired, may perform all of the required measurements during the occasions of the SMTC window that overlap with the DRX ON time period (instead of the DRX OFF time period as shown in FIGS. 6 and 7), and thus may further extend the actual reception OFF period T4′ in FIG. 7 to the entirety of the DRX OFF time period.

In some of these illustrative examples, power consumption may be elevated when performing these beam measurements. Accordingly, if desired, the user equipment may dynamically enable operation described in one or more of the above examples based on certain conditions or during special procedures (e.g., if multiple cells overlap the SMTC window, if the serving cell condition is degrading rapidly due to mobility and handover is needed, etc.).

In addition to the above-mentioned power consumption advantages, user equipment such as user equipment 10 may also advantageously conclude on measurements much faster (e.g., N-times faster if N parallel RX chains are used in parallel). As an illustrative example, during Connected Mode, for Handover, when a new FR2 layer is added to the MeasConfig for the purpose of Handover, the user equipment may perform faster reports to the network, thereby improving Handover performance and user experience. During the same mode, when a new NR FR2 frequency layer is added to the Measurement Configuration for the purpose of PSCell Addition, the user equipment may conclude on the measurement results faster and report to the network, thereby improving user experience since the FR2 link can be added more quickly. As another illustrative example, during Idle Mode, for Early Measurements (e.g., for PSCell Addition), performing faster PSCell Addition may typically come with a power penalty. This power penalty may be reduced, while at the same time user experience may be improved, by utilizing parallel RX chains.

Furthermore, by using parallelized RX chains, the radio such as a cellular radio 26 in user equipment 10 can also increase the scheduling opportunities for radio operations (e.g., RX beam measurement operations). Especially in suboptimal radio conditions (e.g., blockage of signal beams conveyed by one or more antenna arrays), with an increasing number of parallelized RX chains, the number of measurement opportunities are increased. This may provide higher scheduling flexibility of making measurements, for example, of additional neighboring cells, leading to increased overall mobility performance.

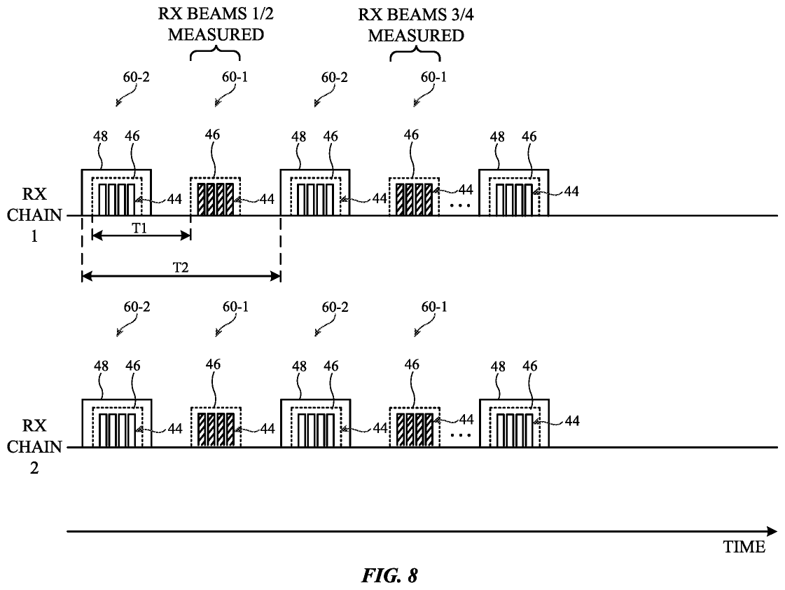

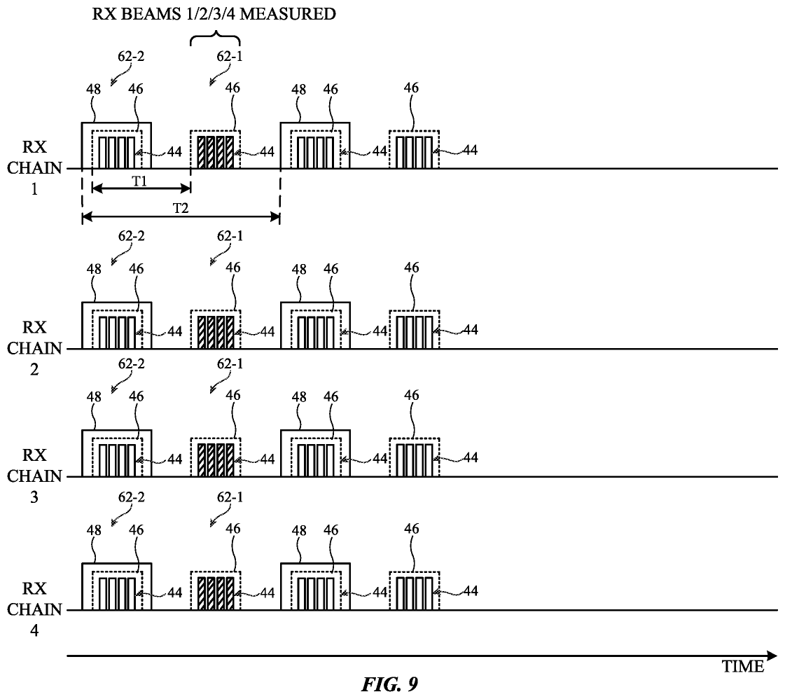

FIGS. 8 and 9 show illustrative timing diagrams of receive chains performing RX beam measurements outside of specified measurement windows such as measurement gap windows. In particular, the RX beam measurements may occur outside of the specified measurement windows in scenarios such as for handling an intra-frequency layer (e.g., configured by the network for mobility measurements, or more specifically, for radio resource management (RRM) measurements) where the intra-frequency SSB is within the active downlink bandwidth part of the user equipment. If desired, the RX beam measurements may occur outside of the specified measurement windows in other scenarios such as for inter-frequency layer measurements, where the inter-frequency SSB is contained in the active downlink bandwidth part of the user equipment (e.g., when configuration “interFreqeuncyConfig-NoGap-r16” is set to True). Configurations in which measurements for the intra-frequency layer are described herein as an illustrative example but may be analogously applied to other scenarios. For this intra-frequency layer (e.g., a NR FR2 intra-frequency layer), a RX beam sweep may be performed (e.g., requiring one SMTC window occasion for each RX beam).

In the illustrative example of FIG. 8, user equipment 10 may use two RX chains such as receive chains 34-1 and 34-2 in FIG. 2 for performing the different sets of RX beam measurements in respective spatial directions associated with the RX beam sweep for an intra-frequency layer. As shown in FIG. 8, at operations 60-1, receive chains 34-1 and 34-2, using one or more antenna arrays 32, may operate in parallel to measure RX beam associated with SSB bursts 44 during SMTC window 46 (e.g., at SMTC window 46 that does not overlap measurement gap window 48). At the first temporally overlapping instance of operation 60-1, receive chain 34-1 may measure a first set of RX beams, while receive chain 34-2 measures a second set of RX beams. At the second temporally overlapping instance of operation 60-1, receive chains 34-1 may measure a third set of RX beams, while receive chain 34-2 measures a fourth set of RX beams. At operations 60-2, the SSB bursts 44 are not measured for the intra-frequency layer.

In the illustrative example of FIG. 9, user equipment 10 may use four RX chains such as receive chains 34-1, 34-2, 34-3, and 34-4 for performing the different sets of beam measurements in respective spatial direction associated with the RX beam sweep for an intra-frequency layer. As shown in FIG. 9, at operations 62-1, receive chains 34-1, 34-2, 34-3, and 34-4, using one or more antenna arrays 32, may operate in parallel to measure RX beam associated with SSB bursts 44 during SMTC window 46 (e.g., at SMTC window 46 that does not overlap measurement gap window 48). At the first and only temporally overlapping instance of operation 62-1, receive chain 34-1 may measure a first set of RX beams, while receive chain 34-2 measures a second set of RX beams, while receive chain 34-3 measures a third set of RX beams, and while receive chain 34-4 measures a fourth set of RX beams. At operations 62-2, the SSB bursts 44 are not measured for the intra-frequency layer.

In both the FIG. 8 and FIG. 9 examples, measurement of the intra-frequency layer may be expedited by sweeping either two (in example of FIG. 8) or four (in the example of FIG. 9) RX beams on the same SMTC window, thus parallelizing the measurement. In these illustrative examples, four coarse RX beams are used to illustrate achieving spherical coverage (similar to the previous examples as described in connection with FIGS. 3-7). If desired, any suitable number of coarse RX beams may be used to achieve spherical coverage for each frequency layer.

In general, the illustrative examples in FIGS. 8 and 9 show SSB burst measurements being performed during SMTC windows that do not overlap or are outside of the measurement gap windows. The overlap may not be required to perform measurements in some scenarios such as for inter-frequency layer measurements, where the inter-frequency SSB is contained in the active downlink bandwidth part of the user equipment (e.g., when configuration “interFreqeuncyConfig-NoGap-r16” is set to True), or for intra-frequency layer measurements where the intra-frequency SSB is within the active downlink bandwidth part of the user equipment, as examples. If desired, instead of or in addition to performing SSB burst measurements during SMTC windows that do not overlap or are outside of the measurement gap windows, SSB burst measurements may be performed during SMTC windows that are within the measurement gap windows.

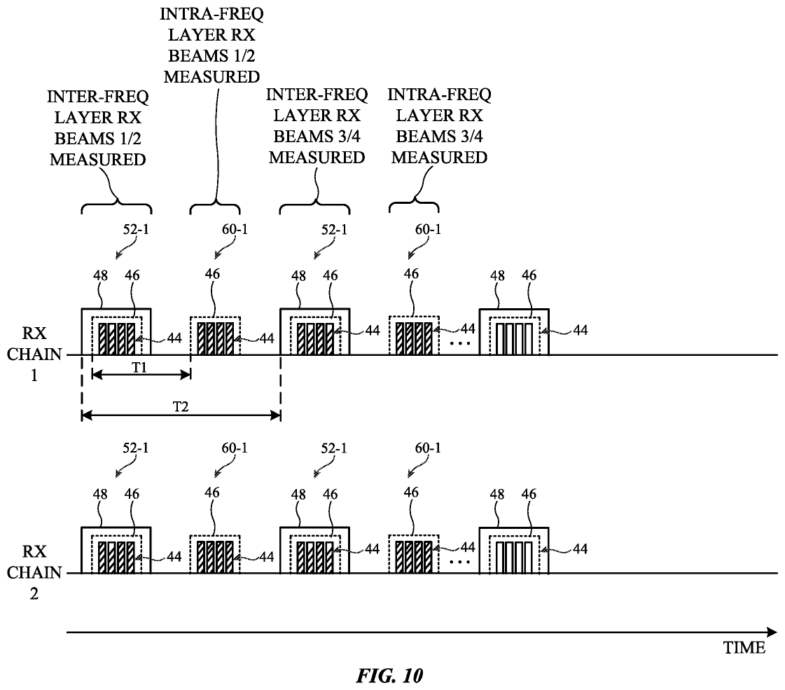

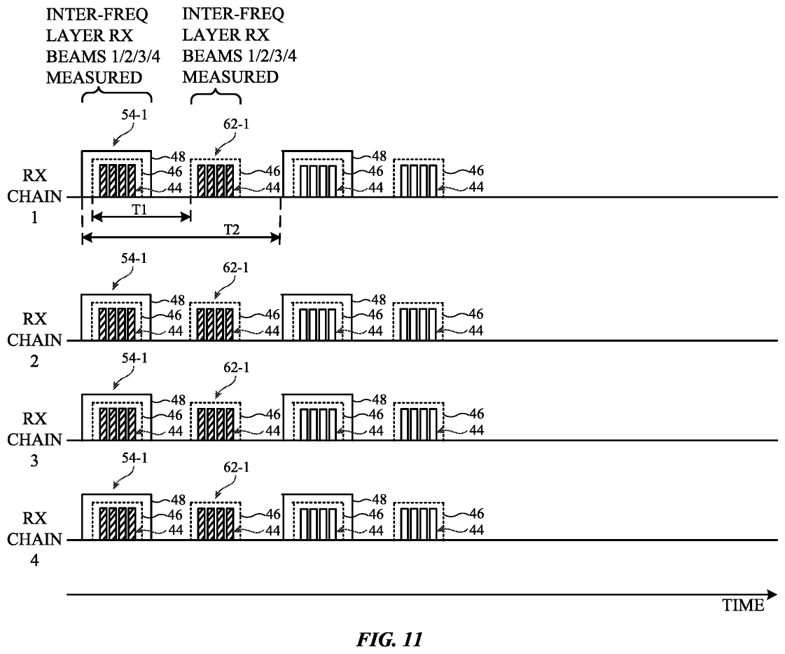

FIGS. 10 and 11 show illustrative timing diagrams of receive chains performing RX beam measurements for handling 1 intra-frequency layer and 1 inter-frequency layer (e.g., configured by the network for RRM measurements). In the illustrative examples of FIGS. 9 and 10, the SMTC windows of the inter-frequency layer and intra-frequency layer may be overlapping.

For the (NR FR2) intra-frequency layer, an RX beam sweep may be performed (e.g., requiring one SMTC window occasion for each RX beam). For the (NR FR2) inter-frequency layer, an additional RX beam sweep may be formed (e.g., requiring one MG window occasion overlapping one SMTC window occasion for each RX beam).

In the illustrative example of FIG. 10, user equipment 10 may use two RX chains such as receive chains 34-1 and 34-2 in FIG. 2 for performing the different sets of RX beam measurements in respective spatial directions associated with the RX beam sweep for an intra-frequency layer and the RX beam sweep for an inter-frequency layer. As shown in FIG. 10, at operations 52-1, receive chains 34-1 and 34-2, using one or more antenna arrays 32, may operate in parallel to measure RX beam associated with SSB bursts 44 during SMTC window 46 (e.g., at SMTC window 46 overlapping measurement gap window 48) for the inter-frequency layer. At the first temporally overlapping instance of operation 52-1, receive chain 34-1 may measure a first set of RX beams associated with the inter-frequency layer, while receive chain 34-2 measures a second set of RX beams associated with the inter-frequency layer. At the second temporally overlapping instance of operation 60-1, receive chains 34-1 may measure a third set of RX beams associated with the inter-frequency layer, while receive chain 34-2 measures a fourth set of RX beams associated with the inter-frequency layer.

As further shown in FIG. 10, at operations 60-1, receive chains 34-1 and 34-2, using one or more antenna arrays 32, may operate in parallel to measure RX beam associated with SSB bursts 44 during SMTC window 46 (e.g., at SMTC window 46 that does not overlap measurement gap window 48) for the intra-frequency layer. At the first temporally overlapping instance of operation 60-1, receive chain 34-1 may measure a first set of RX beams associated with the intra-frequency layer, while receive chain 34-2 measures a second set of RX beams associated with the intra-frequency layer. At the second temporally overlapping instance of operation 60-1, receive chains 34-1 may measure a third set of RX beams associated with intra frequency layer, while receive chain 34-2 measures a fourth set of RX beams associated with intra frequency layer.

In the illustrative example of FIG. 11, user equipment 10 may use four RX chains such as receive chains 34-1, 34-2, 34-3, and 34-4 in FIG. 2 for performing the different set of RX beam measurements in respective spatial directions associated with the RX beam sweep for an intra-frequency layer and the RX beam sweep for an inter-frequency layer. As shown in FIG. 11, at operations 54-1, receive chains 34-1, 34-2, 34-3, and 34-4, using one or more antenna arrays 32, may operate in parallel to measure RX beam associated with SSB bursts 44 during SMTC window 46 (e.g., at SMTC window 46 overlapping measurement gap window 48) for the inter-frequency layer. At the first and only temporally overlapping instance of operation 54-1, receive chain 34-1 may measure a first set of RX beams associated with the inter-frequency layer, while receive chain 34-2 measures a second set of RX beams associated with the inter-frequency layer, while receive chain 34-3 measures a third set of RX beams associated with the inter-frequency layer, and while receive chain 34-4 measures a fourth set of RX beams associated with the inter-frequency layer.

As further shown in FIG. 11, at operations 62-1, receive chains 34-1, 34-2, 34-3, and 34-4, using one or more antenna arrays 32, may operate in parallel to measure RX beam associated with SSB bursts 44 during SMTC window 46 (e.g., at SMTC window 46 that does not overlap measurement gap window 48) for an intra-frequency layer. At the first and only temporally overlapping instance of operation 62-1, receive chain 34-1 may measure a first set of RX beams associated with the intra-frequency layer, while receive chain 34-2 measures a second set of RX beams associated with the intra-frequency layer, while receive chain 34-3 measures a third set of RX beams associated with the intra-frequency layer, and while receive chain 34-4 measures a fourth set of RX beams associated with the intra-frequency layer.

The examples of FIGS. 10 and 11 performing inter-frequency layer measurements during SMTC windows overlapping measurement time periods or measurement gap windows and performing intra-frequency layer measurements during SMTC windows outside the measurement time periods or measurement gap windows are merely illustrative. As described above and reiterated here, other types of measurements such as intra-frequency layer measurements may overlap the measurement time periods or measurement gap windows in some scenarios, and other types of measurements such as inter-frequency layer measurements may not overlap the measurement time periods or measurement gap windows in some scenarios.

In both the FIG. 10 and FIG. 11 examples, the measurement may be expedited by sweeping either two (in the example of FIG. 10) or four (in the example of FIG. 11) RX beams on the same SMTC and/or MG window occasion, thus parallelizing the measurement. In these illustrative examples, four coarse RX beams are used to illustrate achieving spherical coverage (similar to the previous examples as described in connection with FIGS. 3-9). If desired, any suitable number of coarse RX beams may be used to achieve spherical coverage for each frequency layer.

In general, when activating additional receive chains (e.g., receive chains other than the primary receive chain dedicated for performing RX beam measurements), it may be desirable to do so when the primary receive chain is also active (e.g., scheduled to be active). In such a manner, the active/sleep states of the receive chains (whether primary or additional) may be aligned, thereby maximizing the power gain (e.g., power consumption benefit).

While FIGS. 3-11 provide specific durations as examples for different time windows, time periods, or operations, these specific durations are merely illustrative. If desired, these examples may exhibit other durations.

The illustrative examples described in connection with FIGS. 3-11 may be performed using one or more antennas 30 (FIG. 1) arranged in one or more antenna arrays coupled to each of the receive chains to perform the beam measurements. The receive chains may form a portion of one or more radio 26 (FIG. 1). The one or more operations described in connection with FIGS. 3-11 may be performed by one or more processors (associated with one or more of wireless circuitry such as radio(s), control circuitry, etc.) by executing corresponding software instructions for performing these operations stored on non-transitory (tangible) computer-readable storage media.

An aspect of the disclosure provides an electronic device. The electronic device can include one or more antennas associated with one or more antenna arrays. The electronic device can include a first radio-frequency receive chain coupled to the one or more antennas and a second radio-frequency receive chain coupled to the one or more antennas. The electronic device can include one or more processors configured to perform a first beam measurement using the first radio-frequency receive chain while performing a second beam measurement using the second radio-frequency receive chain.

If desired, the one or more processors may be associated with a cellular radio, and the first beam measurement and the second beam measurement may be indicative of a cell status. If desired, the electronic device may be operable to be communicatively coupled to a cellular network, and the first beam measurement and the second beam measurement may overlap a measurement time period associated with the cellular network. If desired, the measurement time period may coincide with a periodicity of a Synchronization Signal and Physical Broadcast Channel block (SSB)-based measurement timing configuration (SMTC) window.

If desired, the first beam measurement and the second beam measurement may be associated with intra-frequency measurements.

If desired, the first beam measurement and the second beam measurement may be associated with inter-frequency measurements. If desired, the one or more processors may be configured to perform a third beam measurement using the first radio-frequency receive chain while performing a fourth beam measurement using the second radio-frequency receive chain, the third beam measurement and the fourth beam measurement being associated with intra-frequency measurements.

If desired, the electronic device may further include one or more additional radio-frequency receive chains each coupled to the one or more antennas, and the one or more processors may be configured to perform one or more additional beam measurements using the one or more additional radio-frequency receive chains. If desired, the first beam measurement, the second beam measurement, and the one or more additional beam measurement each provide a measurement for a different spatial coverage associated with reception of radio-frequency signals from the one or more antennas configured toward a corresponding direction.

An aspect of the disclosure provides a method of operating wireless circuitry. The method can include operating the wireless circuitry in a discontinuous-reception-off mode during a time period. The method can include performing, by a first radio-frequency receive chain in the wireless circuitry, a first beam measurement associated with a cell status during the time period. The method can include performing, by a second radio-frequency receive chain in the wireless circuitry, a second beam measurement associated with the cell status while performing the first beam measurement.

If desired, the method may further include switching the wireless circuitry off during the time period while not performing beam measurements.

If desired, the cell status may include information indicative of a signal power, a signal quality, a timing synchronization, or a frequency synchronization.

An aspect of the disclosure provides a method of operating wireless circuitry communicatively coupled to a cellular network. The method can include operating the wireless circuitry to perform beam measurements during a plurality of measurement gap time periods having a periodicity. The method can include performing, by a first radio-frequency receive chain in the wireless circuitry, a first beam measurement during a given measurement gap time period in the plurality of measurement gap time period and during a timing window associated with the cellular network The method can include performing, by a second radio-frequency receive chain in the wireless circuitry, a second beam measurement during the given measurement gap time period while performing, by the first radio-frequency receive chain, the first beam measurement.

If desired, the timing window may be associated with a Synchronization Signal and Physical Broadcast Channel block (SSB)-based measurement timing configuration (SMTC) window.

If desired, the first beam measurement and the second beam measurement may be associated with inter-frequency measurements. If desired, the method may further include performing, by the first radio-frequency receive chain, a third beam measurement associated with intra-frequency measurements after performing the first beam measurement. If desired, the method may further include performing, by the second radio-frequency receive chain, a fourth beam measurement associated with the intra-frequency measurements after performing the second beam measurement.

If desired, the method may further include performing, by the first radio-frequency receive chain, a third beam measurement associated with intra-frequency measurements after performing the first beam measurement. If desired, the method may further include performing, by the first radio-frequency receive chain, a fourth beam measurement associated with the inter-frequency measurements after performing the second beam measurement. If desired, the method may further include performing, by the second radio-frequency receive chain, additional beam measurements while performing, by the first radio-frequency receive chain, the third and fourth beam measurements.

If desired, the wireless circuitry may include one or more antennas, performing the first cell measurement may include steering radio-frequency signals from the one or more antennas in a first direction, and performing the second cell measurement may include steering radio-frequency signals from the one or more antennas in a second direction.

The foregoing is merely illustrative and various modifications can be made to the described embodiments. The foregoing embodiments may be implemented individually or in any combination.

What is claimed is:

1. An electronic device comprising:
one or more antennas associated with one or more antenna arrays;
a first radio-frequency receive chain coupled to the one or more antennas;
a second radio-frequency receive chain coupled to the one or more antennas; and
one or more processors configured to perform a first beam measurement using the first radio-frequency receive chain while performing a second beam measurement using the second radio-frequency receive chain.

2. The electronic device of claim 1, wherein the one or more processors are associated with a cellular radio, and the first beam measurement and the second beam measurement are indicative of a cell status.

3. The electronic device of claim 2, wherein the electronic device is operable to be communicatively coupled to a cellular network, and the first beam measurement and the second beam measurement overlap a measurement time period associated with the cellular network.

4. The electronic device of claim 3, wherein the measurement time period coincides with a periodicity of a Synchronization Signal and Physical Broadcast Channel block (SSB)-based measurement timing configuration (SMTC) window.

5. The electronic device of claim 1, wherein the first beam measurement and the second beam measurement are associated with intra-frequency measurements.

6. The electronic device of claim 1, wherein the first beam measurement and the second beam measurement are associated with inter-frequency measurements.

7. The electronic device of claim 6, wherein the one or more processors are configured to perform a third beam measurement using the first radio-frequency receive chain while performing a fourth beam measurement using the second radio-frequency receive chain, the third beam measurement and the fourth beam measurement being associated with intra-frequency measurements.

8. The electronic device of claim 1 further comprising:
one or more additional radio-frequency receive chains each coupled to the one or more antennas, wherein the one or more processors are configured to perform one or more additional beam measurements using the one or more additional radio-frequency receive chains.

9. The electronic device of claim 8, wherein the first beam measurement, the second beam measurement, and the one or more additional beam measurements each provide a measurement for a different spatial coverage associated with reception of radio-frequency signals from the one or more antennas configured toward a corresponding direction.

10. A method of operating wireless circuitry comprising:
operating the wireless circuitry in a discontinuous reception mode during a time period;
performing, by a first radio-frequency receive chain in the wireless circuitry, a first beam measurement associated with a cell status during the time period; and
performing, by a second radio-frequency receive chain in the wireless circuitry, a second beam measurement associated with the cell status while performing the first beam measurement.

11. The method of claim 10, further comprising:
switching the wireless circuitry off during the time period while not performing beam measurements.

12. The method of claim 10, wherein the cell status comprises information indicative of a signal power, a signal quality, a timing synchronization, or a frequency synchronization.

13. A method of operating wireless circuitry communicatively coupled to a cellular network, the method comprising:
operating the wireless circuitry to perform beam measurements during a plurality of measurement time periods having a periodicity;
performing, by a first radio-frequency receive chain in the wireless circuitry, a first beam measurement during a given measurement time period in the plurality of measurement time period and during a timing window associated with the cellular network; and
performing, by a second radio-frequency receive chain in the wireless circuitry, a second beam measurement during the given measurement time period while performing, by the first radio-frequency receive chain, the first beam measurement.

14. The method of claim 13, wherein the timing window is associated with a Synchronization Signal and Physical Broadcast Channel block (SSB)-based measurement timing configuration (SMTC) window.

15. The method of claim 13, wherein the first beam measurement and the second beam measurement are associated with inter-frequency measurements or intra-frequency measurements.

16. The method of claim 13 further comprising:
performing, by the first radio-frequency receive chain, a third beam measurement associated with intra-frequency measurements after performing the first beam measurement.

17. The method of claim 16 further comprising:
performing, by the second radio-frequency receive chain, a fourth beam measurement associated with the intra-frequency measurements after performing the second beam measurement.

18. The method of claim 16 further comprising:
performing, by the first radio-frequency receive chain, a fourth beam measurement associated with the inter-frequency measurements after performing the third beam measurement.

19. The method of claim 18 further comprising:
performing, by the second radio-frequency receive chain, additional beam measurements while performing, by the first radio-frequency receive chain, the third and fourth beam measurements.

20. The method of claim 13, wherein the wireless circuitry comprises one or more antennas, performing the first cell measurement comprises steering radio-frequency signals from the one or more antennas in a first direction, and performing the second cell measurement comprises steering radio-frequency signals from the one or more antennas in a second direction.
